(19) United States
(12) Patent Application Publication
(10) Pub. No.: US 2017/0200173 A1
(43) Pub. Date: Jul. 13, 2017

(54) COMPUTERIZED RAFFLE FOR OPTIMAL ASSIGNMENT OF GOODS

(71) Applicant: Microsoft Technology Licensing, LLC, Redmond, WA (US)

(72) Inventors: E. Glen Weyl, Boston, MA (US); Christina Lee, Somerville, MA (US)

(21) Appl. No.: 14/991,590

(22) Filed: Jan. 8, 2016

(51) Int. Cl. G06Q 30/02; G06Q 30/06

(52) U.S. Cl. CPC G06Q 30/0201; G06Q 30/0641

(57) ABSTRACT

A computerized raffle system provides user interface that presents market conditions and enables the market participants to allocate and re-allocate a market resource among one or more raffles of a computerized raffle system. Such a user interface allows the market participants to determine the allocation in light of the strength of their personal preferences, thereby facilitating efficient resource allocation without requiring the use of money. Presentation of the market conditions via the user interface can be choreographed by the computerized raffle system to expedite the convergence of congestion of the market to a state of equilibrium. The computerized raffle system can also send alerts to market participants when certain conditions are met. Once the congestion of the market has converged to a state of equilibrium, the computerized raffle system can distribute goods between market participants based upon the final allocation of market resource.

### BACKGROUND

When money is available, auctions offer a simple way to allocate goods to those who most value them. However, when money cannot be used it is much harder for individuals to express truthfully which goods they value most and by how much. As a result, conventional systems for allocating indivisible goods merely allow market participants to specify a ranking over goods, rather than the relative value they place on different goods. This leads to inefficient allocations; that is everyone could be made better off by a more thoughtfully-designed system.

Additionally, some systems for allocating individual goods are difficult to comprehend, counterintuitive, and frustrating to use. For example, some good allocation systems require users to input a large set of numerical valuations that many users have a difficult time generating.

### SUMMARY

Described herein are techniques and systems for allocating indivisible goods to market participants. The techniques described herein employ a computerized raffle system that accounts for the strength of preferences of individual market participants for particular goods while remaining efficient in large market contexts.

The computerized raffle system can operate in two phases to distribute goods among the market participants. In a first phase, a market resource can be distributed to market participants. The market resource can correspond to entrances into one or more raffles, where different raffles can correspond to different indivisible goods. The individual market participants can allocate the market resource in their possession between different raffles based on their personal preferences. The market resource can be allocated among different raffles via a graphical user interface presented on electronic devices associated with the market participants. Each market participant can also have the ability to change the allocation of (i.e., re-allocate) their particular market resource among the one or more raffles.

At any point during the first phase, or during a subsequent, second phase, the computerized raffle system can determine market data (e.g., a total allocation of market resources among the raffles, allocation of market resource for a particular raffle, congestion of a raffle, a rate of change of the market resource allocated to a particular raffle, etc.) based on allocations and re-allocations of market resource received from the market participants. The graphical user interface can also present instances of market data reflecting a current state of the computerized raffles (e.g., the total market resource allocated to the one or more raffles of the computerized raffle system, etc.). The computerized raffle system can update the user interfaces presented to market participants on their corresponding devices in real time, can update the user interface to display updated information in a delayed and/or staggered manner, or a combination thereof. The delayed and/or staggered manner can be determined by the computerized raffle system to expedite the convergence of the congestion of the market to a state of equilibrium. The computerized raffle system can also send alerts to market participants when certain conditions are met.

Once the congestion of the market has converged to a state of equilibrium, the computerized raffle system can execute the second phase. In the second phase, the indivisible goods are distributed between market participants based upon the final allocation of market resource.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 is a schematic diagram of an example architecture illustrating techniques for conducting a computerized raffle for the allocation of indivisible goods that utilizes the strength of participant preferences while remaining efficient in large market contexts.

FIG. 2 is a schematic diagram illustrating an example computing system for operating a computerized raffle for the allocation of indivisible goods that utilizes the strength of participant preferences while remaining efficient in large market contexts.

FIG. 3 is flow diagram illustrating an example process for operating a computerized raffle system for the distribution of indivisible goods.

FIG. 4 illustrates an example user interface for a computerized raffle system.

FIG. 5 is a flow diagram illustrating an example process for modifying the rate that market data is displayed via a user interface to ensure market convergence.

FIG. 6 illustrates an example system in which an alert is presented to a market participant of a computerized raffle system via an electronic device.

FIG. 7 is a flow diagram illustrating an example process for presenting an alert associated with a computerized raffle system to a market participant.

FIG. 8 is a flow diagram illustrating an example process for distributing goods via a computerized raffle system.

### DETAILED DESCRIPTION

In some one-side matching market scenarios, indivisible goods are distributed among market participants without the use of money and/or transfers between market participants. Examples of such scenarios include the allocation of school enrollment slots (goods) among potential students (market participants), the allocation of classroom seats (goods) among a student body (market participants), employee office assignments, etc. Examples of goods can include, but are not limited to, any type of asset or article, including consumable items, materials, staff/personnel, areas, rights or privileges, slots in a program or other service, etc. This application describes techniques for operating a computerized raffle system that allocates indivisible goods in a way that takes into account the strength of user preferences and thus ensures efficient allocations.

The computerized raffle system can operate in two phases, a first phase during which market participants allocate a market resource among one or more raffles in the computerized raffle system, and a second phase in which the computerized raffle system distributes indivisible goods among the market participants based upon the allocations of the market resource. In the first phase, a market resource (e.g., tickets, raffle entrances, distributive rights of a finite quantity, etc.) is distributed among market participants (e.g., 100 tickets per market participant, etc.). The market resource can include, but is not limited to, any unit or grouping of a finite amount or quantity that can be allocated in any divisible manner by the market participants. For example, the market resource can correspond to a number of tickets that can be placed in a raffle for a good or type of good (e.g., a slot in a particular school system, or a particular type of office location, etc.). In another example, the market resource can correspond to a set resource, where market participants can allocate portions (e.g., fractions, percentage, etc.) of the set resource between the one or more raffles. Individual market participants can allocate their personal market resource between raffles associated with different goods that are to be distributed by the computerized raffle system. The market resource can be allocated by individual market participants via electronic devices associated with the individual market participants.

A raffle of the computerized raffle system corresponds to a system for distributing one or more goods by randomly selecting one or more market resources from among the total market resource allocated to the system. For example, a raffle may correspond to a digital “bucket” to which market participants can allocate tickets (their personal market resource). The raffle may then randomly select a ticket from the total amount of tickets allocated to the bucket, determine a market participant who is associated with the ticket, and then distribute a good to the market participant.

The computerize raffle system can generate graphical user interfaces that include features enabling the market participants to allocate amounts (i.e., percentages, numbers, quantities, etc.) of market resource to individual raffles corresponding to particular goods, types of goods, etc. The graphical user interfaces can allow individual market participants to submit their preferred market resource allocation by typing any nonnegative real-valued vector which sums up to the total number of market resource that the market participant possesses.

The computerized raffle system can receive the allocations of market resource from market participants, and can determine market data (e.g., a total allocation of market resource among the raffles of the computerized raffle system, allocation of market resource for a particular raffle, congestion of a raffle, a rate of change of the market resource allocated to a particular good, etc.) in real time. The congestion of a raffle corresponds to an amount of market resource allocated to a raffle in relation to the number of available goods associated with the raffle. Alternatively, the congestion of a raffle can correspond to a relationship between the number of market participants who have allocated market resource to a raffle and the number of available goods associated with the raffle.

The computerized raffle system can then cause one or more types of the market data to be displayed by the graphical user interfaces. For example, in a market for school enrollment slots, market participants can be presented with information that is indicative of the probability of a market participant being assigned to a school given the amount of market resource (e.g., tickets, etc.) allocated to a raffle corresponding to that school.

During the first phase, the computerized raffle system can also allow individual market participants to change the allocation of (i.e., re-allocate) their market resource. For example, the user interface can provide a market participant the ability to submit a new allocation of their market resource that is to replace their current allocation. The computerized raffle system can store the current market resource allocation of each market participant as market data, and can update this market data based upon re-allocations of market resource received from market participants. As market participants adjust the allocation of their market resource, the computerized raffle system can present information conveying changes in the market data via the graphical user interfaces. Accordingly, the graphical user interface enables market participants to make continuous risk evaluations and re-allocate their market resource so as to more closely align with their personal preferences and risk tolerance.

For example, in a market for enrollment slots at three schools (Ashland, Brown, and County), the computerized raffle system can receive allocations of a market resource between three schools from potential students. The computerized raffle system can then present information to the potential students via the graphical user interfaces, the information notifying the potential students of the current status of the computerized raffle system (e.g., the congestion of each raffle, the total amount of market resource allocated to a raffle, the distribution of market resource across the market, etc.). The potential students can then allocate or re-allocate their market resource among the raffles to specify their personal preferences for each school and the strength of their preferences. Consider two students, who, like most other students, prefer Ashland over Brown and Brown over County. But the first student, Ruth, prefers Ashland greatly over both Brown and County, while the second student John likes both Ashland and Brown quite a bit and views them as quite similar. Given how much people like Ashland, it is likely to be more congested and therefore offer a lower chance that any market resource will secure admission than will Brown, while County may be entirely uncongested. In this scenario, Ruth will choose to allocate the nearly all her market resource to the raffle associated with Ashland, no market resource to Brown, and a minimum amount of market resource to County (to ensure she has a slot in a school if she fails to secure a slot at Ashland). In the same scenario, John will allocate nearly all his market resource to the less highly-congested Brown, as this offers a greater probability of admission. John can be guided to this decision by the information presented on his graphical user interface to determine, namely the congestion associated with each school. This allows both students to maximize their expected values to best align with the strength of her personal preferences.

The computerized raffle system can allow this process of market participants allocating and re-allocating their respective market resource to continue for a pre-determined amount of time, until the occurrence of an event (e.g., a final allocation, a predetermined number of selections received, a command received from a user or external device, etc.), until the distributions of market resource associated with one of the computerized raffle system and/or an individual raffle reach a state of equilibrium, or some combination thereof. However, where the conclusion of this process is dependent on market equilibrium, it is not guaranteed that the distributions will converge to an equilibrium in which every market participant is satisfied with the allocation of their market resource.

The computerized raffle system can ensure convergence to such a state of equilibrium by adjusting the information presented to the market participants. That is, instead of having a fully transparent market, the computerized raffle system can exclusively present a subset of the market data that is determined by the computerized raffle system. The computerized raffle system can select the subset of market data based on one or more factors, including but not limited to, a likelihood that the subset of market data will allow market participants to make informed allocations, to encourage the congestion of the market to reach a state of equilibrium, and the like. For example, one or more market participants can privately submit their preferred allocation of market resource, and the computerized raffle system can selectively present on the graphical user interfaces market data relating to the total distribution of market resource among the different raffles. In this way, the computerized system provides information (e.g. about the congestion of different raffles) for each market participant to make informed determinations relating to his or her optimal placement of market resource, without being distracted with superfluous information.

The computerized raffle system can also adjust the rate that market data relating to the state of the computerized raffle system (e.g., a change in market state) is presented on the graphical user interfaces. For example, the computerized raffle system can utilize mathematical techniques (e.g., global Newton methods, Newton step update, etc.) to determine an optimized rate at which changes in the state of the computerized raffle system are presented on the graphical user interfaces. The computerized raffle system can also identify changes in market state that are likely to disrupt the process of convergence to equilibrium. For example, the computerized raffle system can determine that a first raffle can be very sensitive, in that if its congestion falls by even a small amount, there can be a large in-flow of market resource to the first raffle, disrupting the process of convergence in the raffles of the computerized raffle system. To prevent such a disruption, the computerized raffle system can identify a change in the state of the first raffle, and determine a rate at which the graphical user interface can present market data reflecting this change that is optimized to induce a convergence to a state of equilibrium.

For example, instead of presenting a sudden increase in the congestion of a particular raffle on the graphical user interface in real time, the computerized raffle system can determine two or more portions of the sudden increase, and stagger the presentation of the two or more portions so that the graphical user interface displays a gradual increase in congestion. As each of the two or more portions of the increase is presented, the congestion of individual raffles changes by a small amount, potentially causing the preferred allocation of market resource for individual market participants to also change. Therefore, by staggering the presentation of a change in market state, market participants are able to re-allocate their market resource in light of more subtle changes in market state.

The computerized raffle system can also send alerts (i.e., emails, text messages, social media messages, etc.) to electronic devices associated with market participants. The alerts can be sent to all market participants, or can be sent to a subset of market participants that the computerized raffle system determines are likely to be interested in the alert. The computerized raffle system can determine the likelihood of interest based on one or more factors, including but not limited to, a user profile, information known about the market participant, the market participant's current and/or historical allocation of market resource, selections of the market participant, preferences of the market participant, etc. The alerts can provide an indication of a market state, a change of market state, etc. By sending the alerts, market participants can remain engaged with the computerized raffle system without having to continuously interact with the computerized raffle system (i.e., even when the market participant is “offline” in that he/she is not actively using the computerized raffle system). For example, some markets may exclusively allow market participants to allocate/re-allocate their personal market resource during the first phase. As such, the alerts allow an “offline” market participant to be continuously responsive to market shifts in the computerized raffle system, lest the first phase of the computerized raffle system close without the market participant aligning his/her allocation of personal market resource in response to a change in market conditions. By contrast, if market participants are not actively engaged with the computerized raffle system and does not receive alerts indicating a market state or a change in market state, the computerized raffle system can settle into a state of “false equilibrium” where allocations of market resource remain static due to lack of knowledge regarding time-sensitive information, and not satisfaction/alignment with the strength of market participant's preferences. Such false equilibria delay the convergence of the system to a state where all participants are satisfied with their personal allocations of market resource. Furthermore, alerts keep market participants continuously responsive to market conditions so that the system does not experience long periods of stasis with bursts of high volume activity at certain times (e.g., immediately before a deadline for submitting a final allocation, etc.). Therefore, the provision of alerts to market participants enables the computerized raffle system to overcome the above-mentioned technical problems.

When the market has converged to equilibrium, i.e., the market has reached a state in which every market participant is satisfied with his or her allocation of market resource, the computerized raffle system can proceed to phase 2. The computerized system can also proceed to phase 2 upon the occurrence of one or more other events, including but not limited to, the expiration of a set amount of time, a selection received from a user, or the occurrence of any other type of event.

In phase 2, the computerized raffle system can determine a congestion ratio for individual raffles. The congestion ratio can be the amount of market resource allocated to a raffle divided by the number of available goods in the raffle. Alternatively, the congestion ration can be the number of market participants who have allocated market resource to a raffle divided by the number of available goods in the raffle. If the number of market participants who have allocated market resource to a raffle is less than the number of available goods, the computerized market system can set the congestion ratio to zero, as every market participant who allocated market resource to the raffle is guaranteed a good. The computerized raffle system can identify a raffle with the largest congestion ratio, and distribute the goods associated goods with that raffle. Once a good is distributed to a particular market participant, the remaining market resource associated with the particular market participant can be removed from the raffle. Additionally, after a good is assigned to a market participant, that market participant's remaining market resource can be removed from one or more other raffles. When all of the goods associated with a raffle are distributed to market participants, the system can recompute the congestion ratios of the remaining raffles based on the current amount of market resource allocated to each raffle. The computerized raffle system can then identify a different raffle with the largest remaining congestion ratio, and distribute the goods associated with that raffle. If two or more raffles have the same congestion ratio, the computerized raffle system can randomly choose between any of the most congested raffles.

The techniques described herein can be implemented in whole or in part by one or more electronic devices. In some examples, certain techniques (or portions thereof) can be implemented at an electronic device associated with a user and/or by another electronic device (e.g., a web service). By way of example and not limitation, illustrative systems and devices suitable for implementing the techniques are described below with reference to the figures.

### Example Architecture

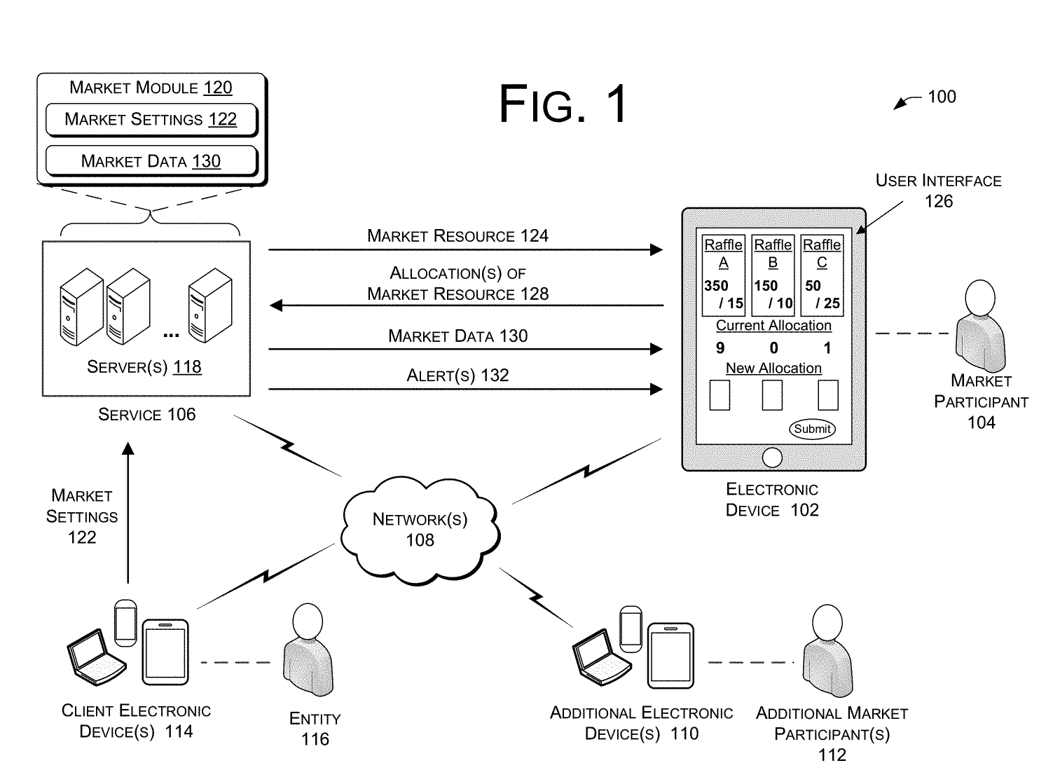

FIG. 1 is a schematic diagram of an example architecture 100 that illustrates techniques for conducting a computerized raffle for the allocation of indivisible goods that utilizes the strength of participant preferences while remaining efficient in large market contexts. Additional details of individual operations illustrated in FIG. 1 and discussed below are described in more detail with reference to subsequent figures.

The architecture 100 includes an electronic device 102 (sometimes referred to as a “computing device 102”) which is associated with a market participant 104. The electronic device 102 can include many different types of electronic devices, including laptops, tablets, smartphones, gaming consoles, set-top-boxes, personal computers, smart televisions, wearable computers (e.g., smart glasses, smart watches, etc.), and so on, as well as different makes and models of teach type of electronic devices. The architecture 100 further includes one or more additional electronic devices 110 (e.g., laptops, tablets, smartphones, gaming consoles, etc.) associated with one or more additional market participants 112, and one or more client electronic devices 114 associated with one or more entities 116. The electronic device 102 can be in communication with one or more of a service 106, an additional electronic device(s) 110, a client electronic device 114, a combination thereof, via a network 108 such as, for example, the Internet or a local wireless network. The service 106 can be implemented or hosted by one or more servers, server farms, data centers, or other computing devices. In the illustrated example, the service 106 is implemented by one or more servers 118.

FIG. 1 illustrates the service 106 hosting a market module 120. In some embodiments, the market module 120 can be hosted on one or more of the electronic device 102, the client electronic device 114, an additional electronic device(s) 110, and a combination thereof, for a client-side implementation of the market module 120. Market module 120 can operate a computerized raffle system that allocates indivisible goods by utilizing the strength of preferences of market participant while remaining efficient in large market contexts.

FIG. 1 further illustrates an example a process that can be used to conduct a computerized raffle that utilizes the strength of participant preferences to efficiently allocate indivisible goods in a large market context. This process can be initiated by the market module 120 receiving one or more market settings 122 for a market environment. The market settings 122 can be received from one or more client electronic devices 114 associated with one or more entities 116. The market settings 122 can identify one or more of raffle conditions, parameters, client preferences, market rules, market participant information, etc. For example, the market settings 122 can include a database of goods that are to be distributed by the computerized raffle system. The market settings 122 can also identify supplemental information associated with the market environment. For example, a school system (entity 116) can submit market settings 122 for a computerized raffle system for allocating classroom registrations (goods) among students (market participants). The market settings 122 can include a database of classroom registrations that are to be distributed, and one or more links to class descriptions and/or registrar information that the school desires to be integrated with the computerized raffle system.

The market settings 122 can be stored on the servers 118, the electronic device 102, an additional client device(s) 110, a client electronic device 114, or a combination thereof. The market module 120 can utilize the market settings 122 to generate and manage a computerized raffle system according to one or more of the market settings 122. For example, the market settings 122 can specify an amount of a market resource (e.g., tickets, raffle entrances, distributive rights, etc.) that is to be distributed among a market participant 104 and one or more additional market participants 112. The market module 120 can then allocate the specified amount of market resource 124 to the market participant 104 and the one or more additional market participants 112 (e.g., 100 tickets per market participant, etc.). The market participant 104 can then allocate her market resource 124 between one or more raffles in the computerized raffle system. For example, the market participant 104 can allocate her market resource via a graphical user interface 126 presented on the electronic devices 102.

The graphical user interface 126 can be generated by the market module 120, and can provide various functionalities. For example, the functionalities can include, but are not limited to, enabling the market participant 104 to assign an amount (i.e., a percentage, number, quantity, etc.) of market resource 124 to individual raffles associated with the computerized raffle. The user interface 126 can allow the market participant 104 to enter an allocation 128 of her market resource 124 by typing any nonnegative real-valued vector which sums up to the total amount of market resource 124 that the market participant 104 possesses. This allocation 128 of market resource can then be transmitted to the market module 120.

The market module 120 can generate market data 130 based on allocations 128 of market resource received from the electronic device 102 and/or the additional electronic device(s) 110. The market data 130 can relate to, but is not limited to, a market participants current allocation 128 of market resource, a total allocation of market resource among the raffles of the computerized raffle system, an allocation of market resource for a particular raffle, a congestion of a raffle, a rate of change of the market resource allocated to a particular raffle, etc. The market module 120 can then cause one or more types of market data 130 to be displayed on user interface 126. For example, in a market for office locations, the user interface 126 can display the total amount of market resource allocated to a particular raffle associated with corner offices. The user interface 126 can also display an indication of the amount of market resource allocated per corner office that is to be distributed by the particular raffle (i.e., the congestion of the raffle). The market participant 104 can then utilize the displayed market data 130 to calculate the probability of being assigned to a corner office given an amount of market resource 124 that she allocates to the particular raffle.

The user interface 126 can also allow the market participant 104 to change the allocation of (i.e., re-allocate) their market resource 124 to a new allocation 128 of market resource. The market module 120 can receive a new allocation 128 of market resource from the electronic device 102 and/or the additional electronic devices 110, and can update the market data 130 based on the new allocation. The market module 120 can then cause the user interface 126 to display one or more instances of the updated market data 130. In this way, as market participants adjust the allocation 128 of their personal market resource, the user interface 126 presents information reflecting a current distribution of market resource allocated within the computerized raffle system. In this way, the user interface 126 enables the market participant 104 to make continuous risk evaluations and re-allocate their market resource so as to more closely align with their personal preferences and risk tolerance.

The market module 120 can exclusively allow market participants to allocate and re-allocate their respective market resource during a pre-determined amount of time, until a condition is achieved, until a command is received, until distributions of market resource associated with one of the market and/or an individual raffle reach a state of equilibrium, or some combination thereof. However, where the process is dependent on the computerized raffle system achieving a state of market equilibrium, it is not guaranteed such a state of equilibrium will ever occur. That is, there is no assurance that the allocations of market resource between one or more raffles of the computerized raffle system will converge to an equilibrium in which all market participants are satisfied with their allocation.

To address the problem of convergence, the market module 120 can adjust the market data 130 displayed on the user interface 126, adjust the way that the market data 130 is displayed on the user interface 126, or both. That is, instead of having a fully transparent market, the market module 120 can cause the user interface 126 to selectively display a subset of the market data 130. The subset of market data 130 can be selected based on a likelihood that the subset of information will allow a market participant to make an informed allocation, the market participant will be interested in the subset of market data, the market environment will be induced to converge to a state of equilibrium, etc. For example, the user interface 126 can display an indication of the rate of change of the congestion of one or more raffles in the computerized raffle system. For example, the user interface 126 can display an indicator that changes colors based on the rate of change of congestion of an associated raffle. For example, when there is a large fluctuation in the associated raffle's congestion, the indicator can be green. Alternatively, as the rate of change of the associated raffle's congestion trends towards equilibrium, the indicator can turn yellow, and when the congestion of the associated raffle reaches equilibrium, the indicator can change to red. The change of color of the indicator can be sudden (i.e., upon the achievement of a threshold) or it can be gradual. In this way, the user interface 126 provides information for each market participant to determine her optimal allocation 128 of market resource, without overwhelming the market participant 104 with superfluous information.

The market module 120 can also adjust the rate that market data 130 is displayed on the user interface 126. For example, the market module 120 can utilize mathematical techniques (e.g., global Newton methods, Newton step update, etc.) to determine a rate at which a change in the state of the market are displayed on the user interface 126. The market module 120 can adjust the rate that all market data 130 is displayed on the user interface 126, or the market module 120 can selectively adjust the display of market data 130 that relates to changes that the market module 120 identifies as being likely to disrupt the convergence to equilibrium. For example, instead of causing the user interface 126 to present a large increase in the congestion of a particular raffle in real time, the market module 120 can break-up the large increase into a number of individual portions and stagger the presentation of the individual portions over time so that the market participant 104 is shown as a gradual increase. By staggering the presentation of a change in raffle state, the market participant 104 is able to re-allocate his or her market resource 124 in light of more subtle changes, while also ensuring that the raffle will eventually converge to a state that all participants are satisfied with.

The market module 120 can also transmit alerts 132 (i.e., emails, text messages, system alerts, pop up messages, social media messages, etc.) to be displayed on electronic device 102. The alerts 132 can provide an indication of a raffle state, a change of raffle state, etc. The alerts 132 can be sent to all market participants, or can be sent to a subset of market participants that the market module 120 determines are likely to be interested in the alert 132. The market module 120 can determine the likelihood of interest based on one or more of a user profile, information known about the market participant, the market participant's current and/or historical allocation of market resource, selections associated with the market participant, preferences of the market participant, etc. For example, the market module 120 can determine that market participants who have allocated or previously allocated market resource to a first raffle are likely to be interested in a decrease in congestion associated with the first raffle.

Additionally, as part of a registration process with the market module 120, the market participant 104 can select rules and thresholds dictating when the market participant 104 will be sent alerts 132. For example, the market participant 104 can submit a congestion threshold at which she is to receive an alert 132 for a corresponding raffle. The market participant 104 can also elect to receive an alert 132 when one or more raffles are nearing convergence to a state of equilibrium. The market participant 104 can also provide one or more methods for the market system 104 to send her alerts 132. For example, the market participant can elect to have alerts 132 sent to a mobile device via a wireless communications network (e.g., texting, etc.). The market participant 104 can elect to have different types of alerts 132 to be delivered according to different methods, or have all alerts 132 delivered by a same method.

Alerts 132 allow market participants to remain engaged with the computerized raffle system without having to continuously interact with the computerized raffle system. As some markets can exclusively allow market participants to allocate/re-allocate their personal market resource during the first phase, the alerts 132 allow a market participant 104 to be continuously responsive to market shifts in the computerized raffle system while in an “offline” scenario, lest the first phase of the computerized raffle system close without the market participant 104 aligning their allocation 128 of personal market resource in response to a change in market conditions. Additionally, if market participants 104 are not actively engaged with the computerized raffle system, the computerized raffle system can settle into a “false equilibrium” where allocations 128 of market resource remain static due to lack of knowledge regarding time-sensitive information, not satisfaction/alignment with the strength of market participant's preferences. Such false equilibria delay the convergence of the system to a state where all participants are satisfied with their personal allocations 128 of market resource. Furthermore, alerts keep market participants 104 continuously responsive to market conditions so that the system does not experience long periods of stasis with bursts of high volume activity at certain times (e.g., immediately before a deadline for submitting a final allocation, etc.). Alerts 132 address these problems by notifying market participants 104 of changes in market state that are likely to provoke a change in allocation 128 of market resource. The alerts 132 can cause the market participant device 102 to launch the graphical user interface 126. The alerts 132 can also include data relating to a change in market state, so that the graphical user interface 126 can display market data 130 reflective of the change in market state. Thus, the market participant 104 can determine whether he or she wants to re-allocate their personal market resource in light of the change in market state without requiring further communication with the service 106.

When the computerized raffle system has converged to a state of equilibrium, i.e., the individual raffles have reached a state in which the market participant 104 and the additional market participants 112 are satisfied with his or her allocation 128 of market resource, the market module 120 can proceed to distribute the goods associated with the raffles of the computerized raffle system. The market module 120 can also begin this distribution upon the expiration of a set amount of time, a selection received from a user, or the occurrence of any similar event.

To distribute the goods, the market module 120 can determine a congestion ratio for individual raffles of the computerized raffle system. The congestion ratio can be the amount of market resource allocated to a raffle in relation to the number of available goods associated with the raffle. Alternatively, the congestion ratio can be the number of market participants who have allocated market resource to a raffle in relation to the number of available goods in the raffle. If the number of market participants who have allocated market resource to a raffle is less than the number of available goods, then the market module 120 can set the congestion ratio for that raffle to zero. The market module 120 can then choose a first raffle with the largest congestion ratio, and distribute goods associated with the first raffle. For example, market resources that have been allocated to the first raffle can be randomly selected, with the goods being distributed to one or more market participants 104 that are associated with the selected market resources.

Once the market module 120 has distributed a good to a first market participant, the market module 120 can remove the market resource associated with the first market participant from the first raffle. Additionally, after a good is assigned to the first market participant, the market module 120 can remove the first market participant's remaining market resource from one or more other raffles. When all of the goods associated with a raffle are distributed, the market module 120 can recompute the congestion ratios of the remaining raffles based on the adjusted amount of market resource allocated to each raffle (e.g., taking into account the market resource that was removed due to an associated market participant receiving a good from another raffle). The market module 120 can then identify a second raffle with the largest remaining congestion ratio, and distribute the goods associated with the second raffle. If one or more raffles have the same congestion ratio out of the remaining raffles, then the market module 120 can randomly choose between any of the most congested raffles.

### Example System for Operating a Computerized Raffle System

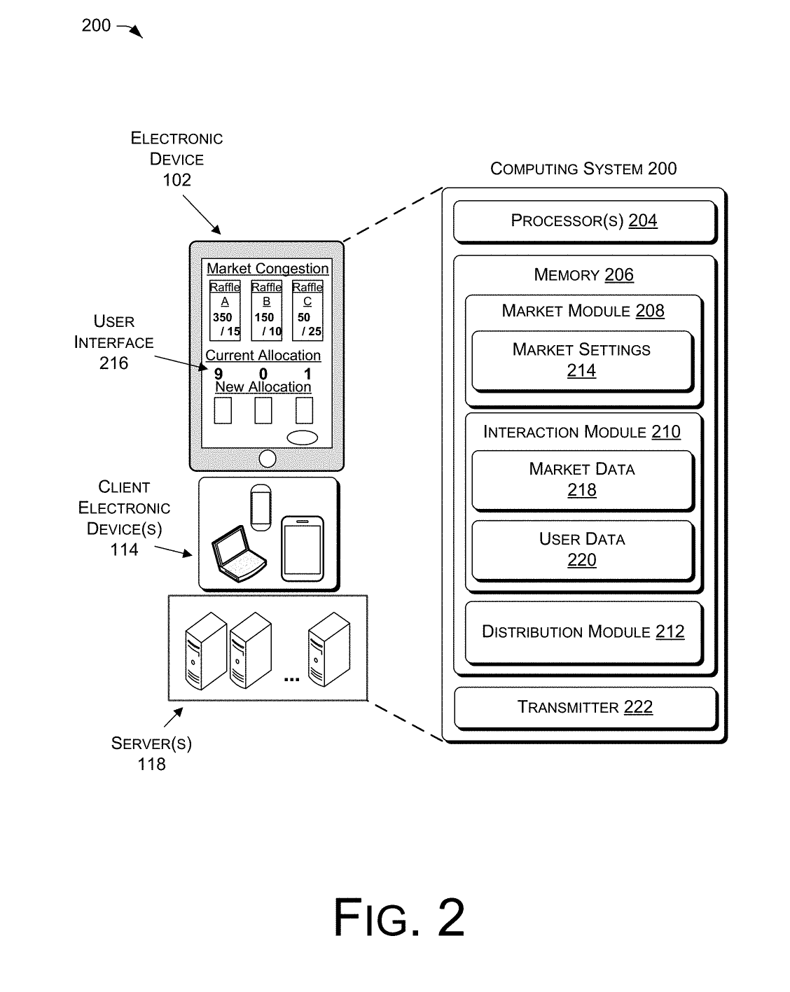

FIG. 2 is a schematic diagram illustrating an example system 200 for operating a computerized raffle for the allocation of indivisible goods that utilizes the strength of participant preferences while remaining efficient in large market contexts. FIG. 2 illustrates additional details of hardware and software components that can be used to implement such techniques described above with reference to FIG. 1. The computing system 200 can include one or more of the electronic device 102, the client device(s) 114, and/or one or more servers 118. Additionally, individual hardware and software components illustrated in FIG. 2 can be present in one or more of the electronic device 102, the client device(s) 114, and/or one or more servers 118. Accordingly, unless otherwise specified, any action or step attributed to any individual hardware or software component can be performed by that component on one or more of the electronic device 102, the client device(s) 114, and/or one or more servers 118. The system 200 is merely one example, and the techniques described herein are not limited to performance using the system 200 of FIG. 2.

In the example of FIG. 2, the computing system 200 includes one or more processors 204, and memory 206 communicatively coupled to the processor(s) 204. The computing system 200 can be implemented as any type of computing device including, but not limited to, a personal computer, a laptop computer, a tablet computer, a portable digital assistant (PDA), a mobile phone (e.g., a smart phone), an electronic book (e-book) reader, a game console, a set-top box (STB), a smart television (TV), a portable game player, a portable media player, a server, and so forth. Additionally, FIG. 2 shows representative electronic device 102 in the forms of a tablet computer 102. However, this is merely an example, and the electronic device 102 according to this application can take other forms.

The computing system 200 can include a market module 208, an interaction module 210, and a distribution module 212 stored in the memory 206. The market module 208 can be executable by the one or more processors 204 to cause one or more processors 204 to perform generate and maintain a computerized raffle system based at least in part upon one or more market settings 214. The market module 208 and the market settings 214 can be the same as, or similar to, market module 120 and market settings 122 as illustrated and discussed with regard to FIG. 1. The one or more market settings 214 can be received via a local device (e.g., keyboard, touchscreen, portable storage device, etc.), or can be received over a network from a remotely located device (i.e., client electronic device 114, etc.) For example, market settings 214 can be received as data indicating one or more electronic/optical signals or commands, and can be stored in a data structure (such as in a memory location or a processor register). Receipt of the electronic/optical signal can result in an interrupt event, which the processor and/or an OS of the system responds to by storing the data indicating the electronic/optical signals and providing a pointer to the data indicating the electronic/optical signals to the market module 208, the interaction module 210, and/or the distribution module 212. These modules are passed an execution thread, and utilize the pointer to read the data indicating the electronic/optical signal from the memory, and process the data to perform operations relating to the computerized raffle system as described in this Detailed Description. The market settings 214 can identify one or more of raffle conditions, parameters, client preferences, market rules, market participant information, etc. The market settings 214 can also identify supplemental information associated with the computerized raffle system. For example, for a computerized raffle for classroom registration, the market settings 214 can include a link to class descriptions and/or registrar information that is to be made available to market participants in connection with the computerized raffle system.

The market module 208 can also allocate a market resource to market participants of the computerized raffle system. The market resource can correspond to entrances into raffles for different indivisible goods being distributed by the computerized raffle system. The market resource can then be allocated by individual market participants between the raffles.

The interaction module 210 can be executable by the one or more processors 204 to cause one or more processors 204 to generate and transmit a user interface 216 to one or more electronic devices 102 associated with one or more market participants. For example, the interaction module 210 can cause a display of the generated user interface 216 by the electronic device 102 by passing a command through an appropriate data structure to an OS or, which can cause, through a device driver, hardware on the device to perform some action, such as via one or more electrical signals from I/O interfaces to the peripheral hardware. For example, a data request can be passed through a data communication protocol stack, resulting in instructions to transmit the data. The display can receive updated display data via a display driver software. The user interface 216 can include an interface for receiving an allocation and/or change of allocation (i.e., re-allocation) of a market participant's personal market resource among the raffles in the raffle system. For example, the market participant can submit her preferred market resource allocation by typing any nonnegative real-valued vector which sums up to the total number of market resource that the market participant has into the user interface 216. Alternatively, or in addition, a market participant can allocate her market resource by dragging and dropping tickets into raffles represented on the graphical user interface by digital buckets, by controlling a slider displayed on the graphical user interface, etc.

The interaction module 210 can receive the allocations and re-allocations of market resource from the electronic devices 102, and can generate market data 218 that describes the market state of the computerized raffle system. For example, the market data 218 can describe information such as a total allocation of market resource among the raffles, an allocation of market resource for a particular raffle, a congestion of a raffle, a rate of change of the market resource allocated to a particular raffle, etc. The interaction module 210 can cause the user interface 216 to display one or more instances of the market data 218. The interaction module 210 can then receive additional allocations and/or re-allocations of market resource from one or more market participants, and can update and/or generate new market data 218. The interaction module 210 can then cause the user interface 216 to display instances of the new/updated market data 218. The interaction module 210 can cause the user interface 216 to display the new/updated market data 218 in real time, at a second rate, or some combination of thereof. For example, interaction module 210 can cause the user interface 216 to display small changes in the congestion of the computerized raffle system in real time, but can cause the user interface 216 to stagger the display of larger changes in congestion so that they appear to a market participant to be more gradual changes.

The interaction module 210 can select the instances of market data 218 that are displayed by the user interface 216, and/or determine the rate that a particular instance of market data 218 is displayed by the user interface 216 based on a likelihood that the instances/rate will expedite the convergence of congestion of the market to a state of equilibrium. For example, the interaction module 210 can utilize mathematical techniques (e.g., global Newton methods, Newton step update, etc.) to determine a rate at which a changes in the state of the computerized raffle system should be displayed on the user interface 216 so as to ensure that the computerized raffle system will converge to a state of equilibrium. The interaction module 210 can determine the rate that all instances of market data 218 are displayed on the user interface 216 using mathematical techniques, or the interaction module 210 can perform such a determination for market data 218 that the interaction module 210 identifies as having a high likelihood of disrupting the convergence of the computerized raffle system to a state of equilibrium. For example, the interaction module 210 can identify a first raffle as being very sensitive (i.e., if the congestion of the first raffle changes by even a small amount, there will be a large in change in the allocation of market resource to the first raffle), the interaction module 210 can identify a change to the congestion of the first raffle as being likely to disrupt the convergence of the first raffle to a state of equilibrium. The interaction module 210 can identify a change as being likely to disrupt the convergence of one or more raffles to a state of equilibrium based on a comparison of the change with one or more thresholds. The thresholds can be predetermined, the interaction module 210 can determine the one or more thresholds based on market data 218 (e.g., allocation of market resource, the sensitivity of the corresponding raffle, etc.), or some combination thereof.

Once the interaction module 210 has identified a change that is likely to disrupt the convergence of one or more raffles to a state of equilibrium, the interaction module 210 can adjust the rate at which the market participants are shown this change so as to induce the market to converge to a state of equilibrium. For example, instead of causing the user interface 216 to present a sudden increase in the congestion of a first raffle in real time, the interaction module 210 can determine individual portions of the increase, and stagger the display of the individual portions via the user interface 216 over a period of time. While the staggered portions of the increase in congestion is being displayed on the user interface 216 (i.e., before all of the determined portions are displayed), market participants are able to allocate and/or re-allocate their market resource via the user interface 216. Thus, the user interface 216 generated by the interaction module 210 allows individual market participants to allocate and re-allocate their market resource in a dynamic market setting, and in a way that reflects the strength of the preferences and risk tolerance of the individual market participants, while also ensuring that the market will eventually converge to a state that all participants are satisfied with.

The interaction module 210 can also cause alerts (i.e., emails, text messages, social media messages, etc.) to market participants when certain conditions are met. The alerts can provide an indication of a raffle state, a change of raffle state, etc. The alerts can be sent to all market participants, or can be sent to a subset of market participants that the interaction module 210 determines are likely to be interested in the alert. The interaction module 210 can determine the likelihood of interest based on user data 220 associated with the market participants. The user data 220 can include user profile, information known about the market participant, the market participant's current and/or historical allocation of market resource, selections of the market participant, preferences of the market participant, etc. For example, the interaction module 210 can determine that market participants who have allocated or previously allocated market resource to a first raffle are likely to be interested in a decrease in congestion associated with the first raffle. The user data 220 can be determined by the interaction module 210, can be received from an electronic device 102 associated with a market participant (e.g., as part of a registration process with the computerized raffle system).

The distribution module 212 can be executable by the one or more processors 204 to cause one or more processors 204 to distribute one or more goods associated with the raffles of the computerized raffle system among the market participants. The distribution module 212 can initiate the distribution of the one or more goods based upon the expiring of a set amount of time, a selection received from a user, the occurrence of an event, convergence of the computerized raffle system to a state of equilibrium, etc., or some combination thereof. To distribute the goods, the distribution module 212 can determine a congestion ratio for individual raffles. The congestion ratio is the amount of market resource divided by the number of available goods in a corresponding raffle. The distribution module 212 then chooses a first raffle with the largest congestion ratio, and raffles away the associated goods in the first raffle. For example, in a computerized raffle system where each unit of market resource corresponds to a single raffle ticket, the distribution module 212 can select one or more raffle tickets from the total number of raffle tickets allocated to the first raffle, and assign goods to the market participants associated with the selected raffle tickets. Once the distribution module 212 has assigned a good to a first market participant, the distribution module 212 can remove the market resource associated with the first market participant from the first raffle. Additionally, after the good is assigned to the first market participant, the distribution module 212 can remove the first market participant's remaining market resource from one or more other raffles. When all of the goods associated with a raffle are distributed, the distribution module 212 can recompute the congestion ratios of the remaining raffles based on the adjusted amount of market resource allocated to each raffle (e.g., taking into account the market resource that was removed due to an associated market participant receiving a good from another raffle). The distribution module 212 can then identify a second raffle with the largest remaining congestion ratio, and raffles away the goods associated with the second raffle. If one or more raffles have the same congestion ratio out of the remaining raffles, then the distribution module 212 can uniformly randomly choose between any of the most congested raffles.

The processor(s) 204 can be configured to execute instructions, applications, or programs stored in the memory 206. In some examples, the processor(s) 204 can include hardware processors that include, without limitation, a hardware central processing unit (CPU), a graphics processing unit (GPU), a field programmable gate array (FPGA), a complex programmable logic device (CPLD), an application specific integrated circuit (ASIC), a system-on-chip (SoC), or a combination thereof.

The memory 208 is an example of computer-readable media. Computer-readable media can include two types of computer-readable media, namely computer storage media and communication media. Computer storage media can include volatile and non-volatile, removable, and non-removable media implemented in any method or technology for storage of information, such as computer readable instructions, data structures, program modules, or other data. Computer storage media includes, but is not limited to, random access memory (RAM), read-only memory (ROM), erasable programmable read-only memory (EEPROM), flash memory or other memory technology, compact disc read-only memory (CD-ROM), digital versatile disk (DVD), or other optical storage, magnetic cassettes, magnetic tape, magnetic disk storage or other magnetic storage devices, or any other non-transmission medium that can be used to store the desired information and which can be accessed by a computing device, such as electronic device 102, additional electronic devices 110, or servers 114. In general, computer storage media can include computer-executable instructions that, when executed by one or more processors, cause various functions and/or operations described herein to be performed.

In contrast, communication media embody computer-readable instructions, data structures, program modules, or other data in a modulated data signal, such as a carrier wave, or other transmission mechanism. As defined herein, computer storage media does not include communication media.

Additionally, the transmitter 222 includes physical and/or logical interfaces for connecting the respective computing device(s) to another computing device or a network. For example, the transmitter 222 can enable WiFi-based communication such as via frequencies defined by the IEEE 802.11 standards, short range wireless frequencies such as Bluetooth®, or any suitable wired or wireless communications protocol that enables the respective computing device to interface with the other computing devices.

The architectures, systems, and individual elements described herein can include many other logical, programmatic, and physical components, of which those shown in the accompanying figures are merely examples that are related to the discussion herein.

### Example Process for Operating a Computerized Raffle System

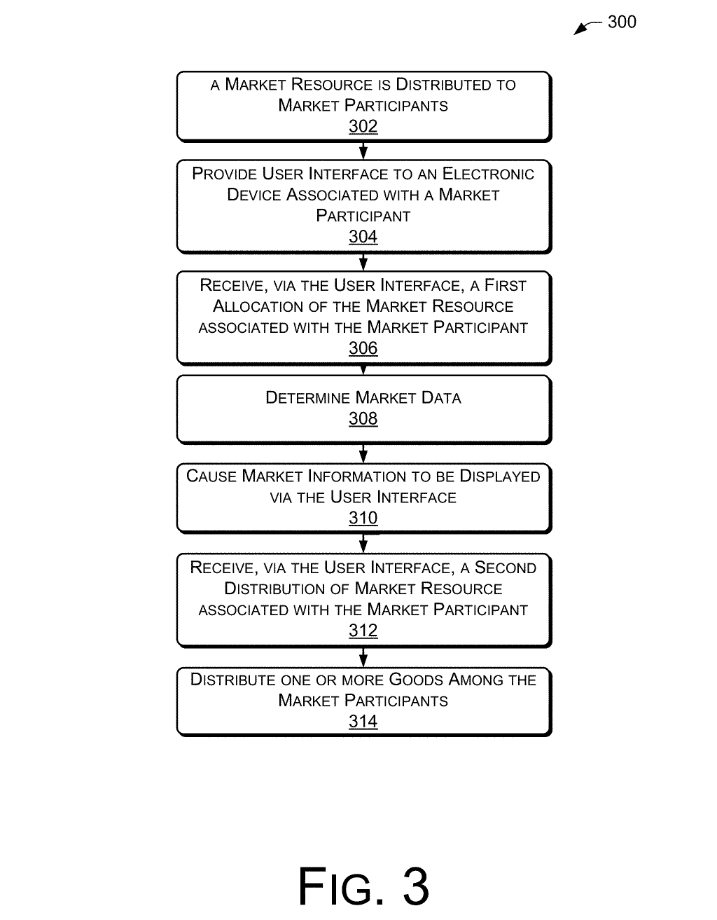

FIG. 3 is flow diagram of an example process 300 of operating a computerized raffle system for the distribution of indivisible goods. One or more steps of process 300 can be performed by a service over a backend content delivery network (i.e. the cloud), by another electronic device over a network, as a local process by an electronic device, as a local process by an additional electronic device, or by a combination thereof.

As shown in FIG. 3, at operation 302, a market resource is distributed to market participants. The market resource can correspond to entrances into individual raffles in a computerized raffle system, the individual raffles being associated with one or more indivisible goods (e.g., tickets, raffle entrances, distributive rights, etc.).

At operation 304, the market system provides a user interface to an electronic device associated with a market participant. The graphical user interface can be generated by the market system, and can provide various functionalities, the functionalities including at least enabling the market participants to assign an amount (i.e., a percentage, number, quantity, etc.) of market resource to individual raffles associated with the computerized raffle. For example, the user interface can allow the market participant to enter an allocation of their market resource by typing any nonnegative real-valued vector which sums up to the total number of market resource that the market participant has.

At operation 306, market system receives, via the user interface, a first allocation of the market resource associated with the market participant. The first allocation can be received over a network, over a wired connection, via internal processing of the electronic device, or some combination thereof.

At operation 308, the market system determines market data. The market data can be based on one or more allocations of market resource received from one or more electronic devices. Examples of market data include total allocation of market resource among the goods, allocation of market resource for a particular good, congestion of a good, a rate of change of the market resource allocated to a particular good, etc.

At operation 310, the market system causes market information to be displayed via the user interface. For example, the user interface can display an indication of the amount of market resource allocated per good that is to be distributed by the individual raffle (i.e., congestion of the raffle). The market system can cause the user interface to exclusively display a subset of the market data. The market system can select the subset of market data based on a likelihood that the subset of information will allow for market participants to make informed allocations, to encourage the congestion of the market to reach a state of equilibrium, etc. The market system can also adjust the rate that market data is displayed on the user interface. For example, the market system 126 can utilize mathematical techniques (e.g., global Newton methods, Newton step update, etc.) to determine a rate at which the raffle is ensured to eventually converge to a state of equilibrium.

At operation 312, market system receives, via the user interface, a second allocation of the market resource associated with the market participant. The second allocation can be received over a network, over a wired connection, via internal processing of the electronic device, or some combination thereof. This allocation can be a new allocation of market resource, a re-allocation of a previous allocation (e.g., an adjustment of the first allocation), or the like.

At operation 314, the market system distributed one or more goods among the market participants. The distribution of the one or more goods can be initiated based upon the expiring of a set amount of time, a selection received from a user, the occurrence of an event, convergence of the computerized raffle system to a state of equilibrium, etc., or some combination thereof. A state of equilibrium of the computerized raffle system can correspond to the level of fluctuation of the total allocation of market resource between the raffles of the computerized raffle system meeting or falling below a threshold.

To distribute the one or more goods, the market system can determine a congestion ratio for individual raffles of the computerized raffle system. The congestion ratio is the amount of market resource divided by the number of available goods in a corresponding raffle. The market system then chooses a first raffle with the largest congestion ratio, and distribute one or more goods associated with the first raffle. For example, market resources that have been allocated to the first raffle can be randomly selected, with the goods being distributed to one or more market participants 104 that are associated with the selected market resources. Once the market system has distributed a good to a first market participant, the market system can remove the market resource associated with the first market participant from the first raffle. Additionally, after the good is assigned to the first market participant, the market system can remove the first market participant's remaining market from one or more other raffles. When all of the goods associated with a raffle have been distributed, the market system can recompute the congestion ratios of the remaining raffles based on the adjusted amount of market resource allocated to each raffle (e.g., taking into account the market resource that was removed due to an associated market participant receiving a good from another raffle). The market system can then identify a second raffle with the largest remaining congestion ratio, and raffles away the goods associated with the second raffle.

### Example User Interface for a Computerized Raffle System

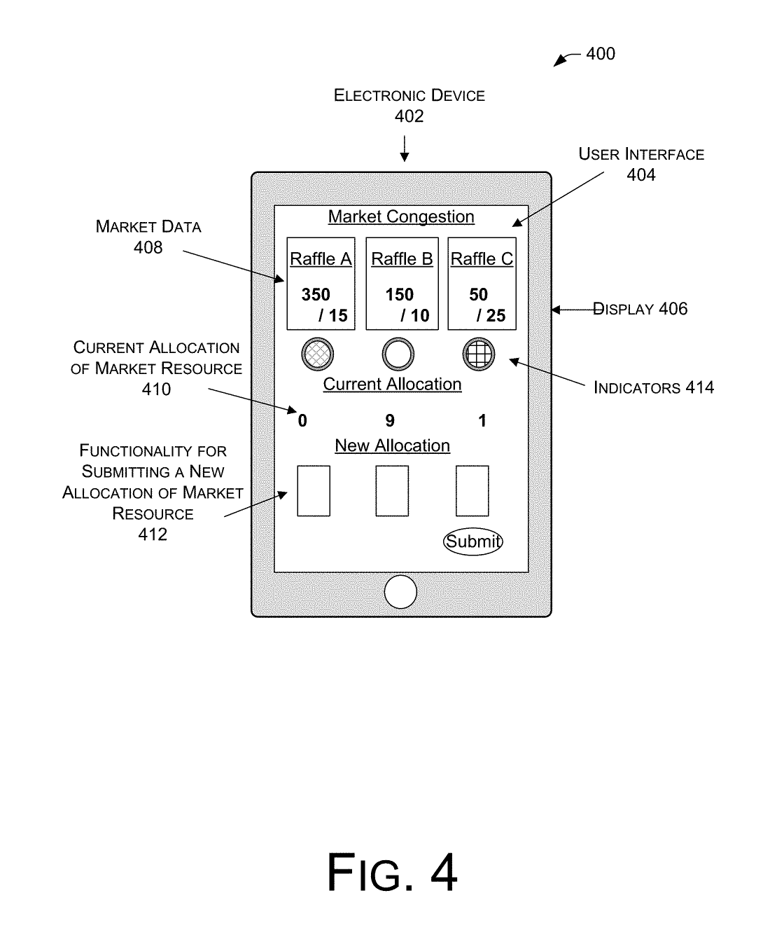

FIG. 4 illustrates an example user interface for a computerized raffle system. FIG. 4 shows representative electronic device 402 in the forms of a tablet computer 402. However, this is merely an example, and the electronic device 402 according to this application can take other forms.

FIG. 4 illustrates a user interface 404 presented on a display 406 associated with the electronic device 402. The user interface 404 can be generated by a module executed on the electronic device 404, by one or more external devices and transmitted over one or more connections (e.g., wired, network, etc.), or some combination thereof. The user interface 404 can include one or more instances of market data 408. The market data 408 can be based on one or more allocations of market resource received from one or more electronic devices. FIG. 4 illustrates the market data 408 as the congestion of the raffles in the computerized raffle system; however market data 408 can also include a total allocation of market resource among computerized raffle system, allocation of market resource for a particular raffle, a rate of change of the market resource allocated to a particular good, etc. For example, FIG. 4 illustrates the graphical user interface 404 displaying market congestion (market data 408) for each of raffles A, B, and C. Specifically, FIG. 4 illustrates that the congestion of Raffle A corresponds to 350 market resource to 15 goods, that the congestion of Raffle B corresponds to 150 market resource to 10 goods, and that the congestion of Raffle C corresponds to 50 market resource to 25 goods. In this way, the graphical user interface 404 allows a market participant to determine, for example, that due to Raffle A being so congested (i.e., the odds of being distributed a good from Raffle A being so low), the market participant would prefer to allocate her personal market resource to Raffle B.

The market data 408 can be presented on the user interface 404 in real time so as to reflect current market conditions of the computerized raffle system, can be presented in a modified rate, or a combination thereof. For example, one or more of the electronic device, additional electronic devices, a service, etc. can utilize mathematical techniques (e.g., global Newton methods, Newton step update, etc.) to determine a rate at which a changes in the market state of the computerized raffle system can be displayed on the user interface 404 to ensure that the computerized raffle system will converge to a state of equilibrium.

The user interface 404 can display a current allocation of market resource associated with a market participant 410. The user interface 404 can also include a functionality that allows the market participant to submit a new allocation (i.e., re-allocate) her market resource 412. Thus, a market participant my utilize functionality 412 re-allocate their market resource based on dynamic market data 408 displayed by the user interface 404. In this way, user interface 404 enables market participants to modify their allocation of market resource in a way that reflects the strength of their preferences and risk tolerance, while also ensuring that the market will converge to a state of equilibrium.

FIG. 4 also illustrates the user interface 404 including indicators 414 of the rate of change of the congestion of the raffles in the computerized raffle system. For example, each indicator 414 can change its color to reflect a level of fluctuation of congestion associated with the raffle. Such a change of color of the indicator 414 can be sudden (i.e., upon the achievement of a preset threshold) or it can be gradual. In this way, indicators 414 provide information for each market participant to determine her optimal placement of market resource, without overwhelming the market participant with superfluous information.

### Example Process for Modifying the Display of Market Data to Induce Market Convergence

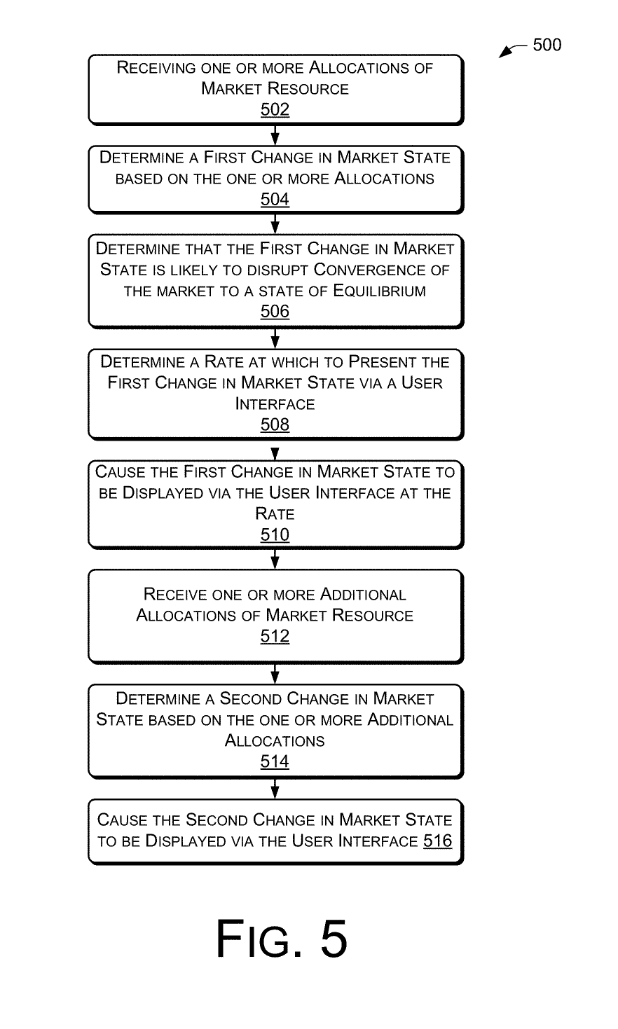

FIG. 5 is a flow diagram of an example process 500 for modifying the rate that market data is displayed via a user interface to ensure market convergence. One or more steps of process 500 can be performed by a service over a network (i.e. the cloud), as a local process by an electronic device, as a process by an additional electronic device, or by a combination thereof.

As shown in FIG. 5, at operation 502, the market system receives one or more allocations of market resource. The one or more allocations can be received over a network, over a wired connection, via internal processing of the electronic device, or some combination thereof

At operation 504, market system determines a first change in market state based on the one or more allocations. The first change in market state can include a change in the total allocation of market resource among the raffles of a computerized raffles system, a change in the allocation of market resource for a particular raffle of the computerized raffle, a change of the congestion of a raffle, etc.

At operation 506, the market system determines that the first change in market state is likely to disrupt convergence of the market to a state of equilibrium. The market system can identify a change as being likely to disrupt the convergence of the market to a state of equilibrium based on a comparison of the change with one or more thresholds. The thresholds can be predetermined, the market system can determine the one or more thresholds based on market data (e.g., allocation of market resource, the sensitivity of the corresponding raffle, etc.), or some combination thereof.

At operation 508, the market system determines a rate at which to present the first change in market state via a user interface. For example, instead of causing the user interface to present the first change in real time, the market system can determine individual portions of the increase, and stagger the display of the individual portions by the user interface over a period of time. For example, the market system can utilize mathematical techniques (e.g., global Newton methods, Newton step update, etc.) to determine a rate at which the first change in the market state is displayed by the user interface.

At operation 510, the market system causes the first change in market state to be displayed via the user interface at the rate. While the first change in market state is being displayed on the user interface (i.e., before all of the determined portions are displayed), the user interface can allow market participants to allocate and/or re-allocate their market resource. Thus, the user interface allows individual market participants to allocate and re-allocate their market resource based on a partial presentation of the first change of market state (i.e., before the entire first change is presented to the user).

At operation 512, the market system receives on or more additional allocations of market resource. The one or more additional allocations can be received over a network, over a wired connection, via internal processing of the electronic device, or some combination thereof.

At operation 514, the market system determines a second change in market state based on the one or more additional allocations. The second change in market state can include a change in the total allocation of market resource among the raffles of a computerized raffles system, a change in the allocation of market resource for a particular raffle of the computerized raffle, a change of the congestion of a raffle, etc.

At operation 516 the market system causes the second change to be displayed via the user interface. Where the entire first change has not been presented to the user, the market system can cause the user interface to stop presenting the remaining portions of the first change, and instead cause the user interface to display the second change.

### Example System for Providing Alerts for Computerized Raffle System

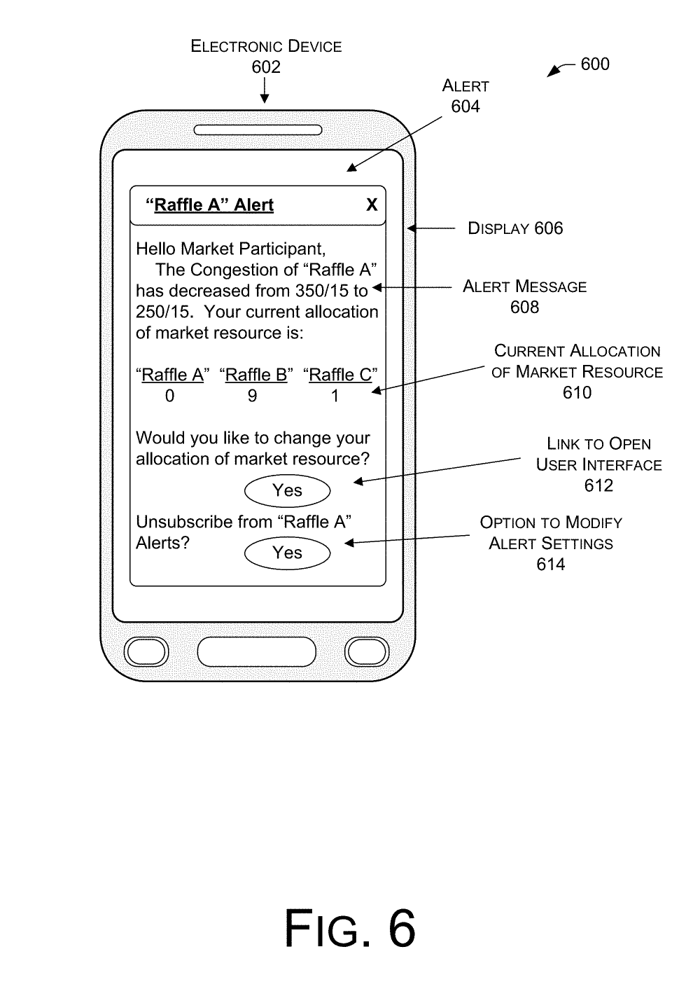

FIG. 6 illustrates an example diagram where an alert is presented to a market participant of a computerized raffle system via an electronic device. FIG. 6 shows a representative electronic device in the form of a mobile phone. However, this is merely an example, and the electronic device according to this application can take other forms.

FIG. 6 illustrates an electronic device 602. FIG. 6 also illustrates an alert 604 presented on a display 606 of the electronic device 602. The alert 604 can be in the form of a text message, email message, social media message, etc. that is associated with a market participant. The alert 604 can also be presented as a popup notification generated by a local application associated with the computerized raffle system, such as in the form of a push notification. For example, the local application associated with the computerized raffle system can receive a command and/or market data as part of a background operation, and based on the command/market data can cause the alert 604 to be presented on the display 606 of the electronic device 602.

The alert 604 can include an alert message 608 that describes one or more of a change in market state, or an anticipated change in market state. FIG. 6 illustrates an alert message 608 relating to change in the congestion associated with the raffle. Other examples of changes/anticipated changes in market state that alert message 608 can include, but are not limited to, a change in market resource allocated to a raffle, a change in the rate at which market resource is being allocated to a raffle, the allocation of market resource to a raffle approaching a state of equilibrium, that the time period in which allocations of market resource can be change is coming to an end, etc. The alert 604 can be sent to one or more market participants upon a determination that a change in state of the computerized market system meets or exceeds a threshold. The threshold can be predetermined, set by a market participant, determined by a module based on current market conditions of the computerized raffle system, etc. For example, a module may determine a smaller threshold associated with a first raffle that is near equilibrium, and a larger threshold associated with a second raffle that experiences large fluctuations in market resource allocation.

The alert message 608 can also present the current allocation of market resource 610 associated with a market participant associated with the electronic device 602. The alert 604 can also include link to open a user interface 612 associated with the computerized raffle system. The link can cause the electronic device 602 to launch an application associated with the computerized raffle system. The alert 604 can also include market data that enables the application associated with the computerized raffles system to cause one or more of the electronic device 602 and one or more additional electronic device to display a user interface that presents current market conditions of the computerized raffle system. The alert 604 can also include an option to modify alert settings 614 associated with the user. Selection of option 614 can cause the electronic device 602 to modify alert settings associated with the user and stored locally on the electronic device 602, can cause the electronic device 602 to send a command to modify alert settings associated with the market participant stored on a server, additional electronic device, etc., or a combination thereof.

In this way alert 604 enables a market participant to remain engaged with the computerized raffle system without having to continuously interact with the computerized raffle system. This overcomes the problem of the computerized raffle system closing without the market participant having the opportunity to align the allocation of his personal market resource in response to a change in market conditions. Furthermore, without having alerts that keep all market participants continuously responsive to market conditions, the computerized raffle system is prone to long periods of stasis with bursts of high volume activity at certain times (e.g., immediately before a deadline for submitting a final allocation, etc.), which hinders the convergence of computerized raffle system to a state of equilibrium. Alert 604 address these problems by notifying, with the user of computer networking technology, market participants of changes in market state that are likely to provoke a change in allocation of market resource. That is, alert 604 creates a market scenario where market participants actively engage with the computerized raffle system to cause the system to converge to a state of equilibrium that all market participants are satisfied with, without the market participants needing to constantly monitor the state of the computerized raffle system.

### Example Process for Presenting an Alert in a Computerized Raffle System

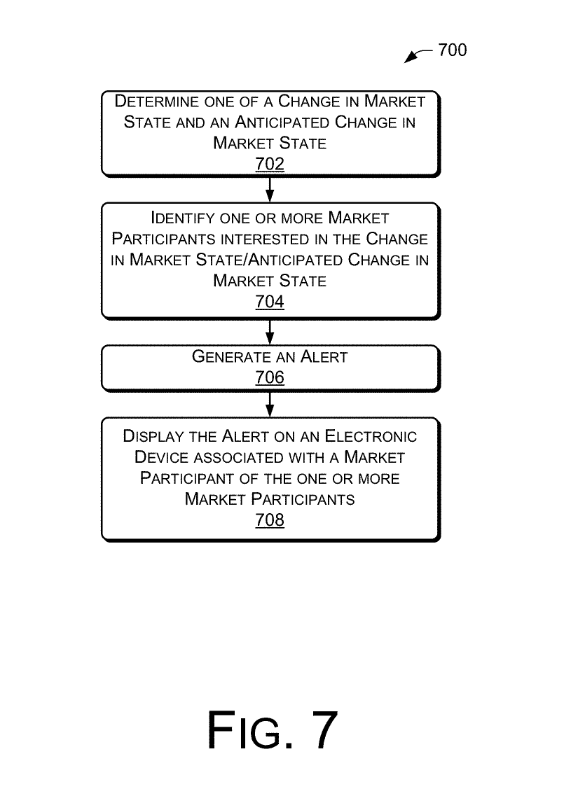

FIG. 7 is a flow diagram of an example process 700 for presenting an alert associated with a computerized raffle system to a market participant. One or more steps of process 700 can be performed by a service over a network (i.e. the cloud), as a local process by an electronic device, as a process by an additional electronic device, or by a combination thereof

As shown in FIG. 7, at operation 702, one of a change in market state and an anticipated change in market state is determined. Determination 702 can be made by the market service based on one or more allocations of market resource received from one or more electronic devices associated with market participants. Alternatively, or in combination, determination 702 can be made by a local operation on an electronic device, based on, for example but not limited to, one or more instances of market data received from the market service.

At operation 704, one or more market participants interested in the change in market state/anticipated change in market state are identified. Identification 704 can include the market system determining that all market participants are interested in the change/anticipated change, or that a subset of market participants are interested. For example, the market system can determine that a first set of market participants who have currently allocated market resource to a first raffle are likely to be interested in an increase in the congestion associated with the first raffle, while a second set of market participants who previously (but no longer) had allocated market resource to the first raffle are not likely to be interested in the increase in congestion.

Identification 704 can include the market system assigning a numerical likelihood of a market participant being interested in the change/anticipated change, and comparing the numerical likelihood to one or more thresholds. The market system can determine the numerical likelihood of a market participant having an interest in the change/anticipated change based on user data associated with the market participant. The user data can include a user profile, information known about the market participant, a market participant's current and/or historical allocation of market resource, selections of the market participant, preferences of the market participant, etc. The user data can be determined by the market system, can be received from an electronic device associated with a market participant (e.g., as part of a registration process with the computerized raffle system), etc.

At operation 706, an alert is generated. The alert can be generated by the market system, or by the electronic device associated with a market participant. The alert can include an alert message describing the change/anticipated change in market state. For example, the alert message can relate to an anticipated convergence of the amount of market resource allocated to a raffle to a state of equilibrium. Other examples of changes/anticipated changes in market state that alert message can relate to include, but are not limited to, a change in market resource allocated to a raffle, a change in the rate at which market resource is being allocated to a raffle, that the time period in which allocations of market resource can be change is coming to an end, etc.

The alert can also present the current allocation of market resource associated with the market participant associated with the electronic device. The alert can also include link to open a user interface associated with the computerized raffle system. The link can cause the electronic device to launch an application associated with the computerized raffle system. The alert can also include an option to modify alert settings associated with the user.

At operation 708, the alert is displayed on an electronic device associated with a market participant of the one or more market participants. The alert can also be displayed on one or more additional electronic device associated with the market participant.

### Example Process for Distributing Goods via a Computerized Raffle System

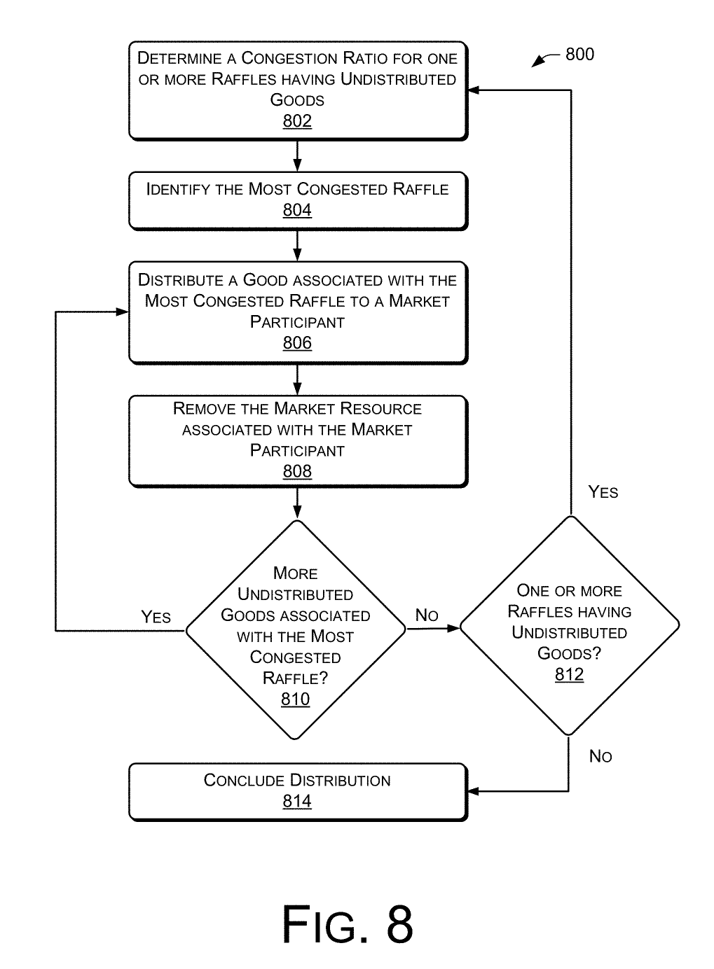

FIG. 8 is a flow diagram of an example process 500 for distributing goods via a computerized raffle system. One or more steps of process 800 can be performed by a service over a network (i.e. the cloud), as a local process by an electronic device, as a process by an additional electronic device, or by a combination thereof.

As shown in FIG. 8, at operation 802, the market system determines a congestion ratio for one or more raffles having undistributed goods. The congestion ratio is the amount of market resource divided by the number of available goods in a corresponding raffle.

At operation 804, market system identifies the most congested raffle of the one or more raffles having undistributed goods. If more than one raffle has the same congestion ratio, then the market system can uniformly randomly choose between any of the most congested raffles. The system can also choose based on preset rules, market data, market settings, or a combination thereof.

At operation 806, the market system distributes a good associated with the most congested raffle to a market participant. To receive a good via the raffle, the market participant must have allocated at least a portion of their market resource to the raffle. The good can be distributed to the market participant based on the result of the market system conducting a raffle based on the total market resource assigned to the most congested raffle.

At operation 808, the market system can remove the market resource associated with the market participant. For example, the market system can remove market resource associated with the market participant from the raffle from which the market participant was distributed a good. Additionally, after the good is distributed to the market participant, the market system can remove the market participant's remaining market resource from one or more other raffles.

At operation 810, the market system determines whether there are more goods associated with the congested raffle that have yet to be distributed. If there are, then process 800 continues at operation 806, and an additional good associated with the most congested raffle is distributed a market participant. The additional good can be distributed based on the remaining market resource assigned to the most congested raffle. If there are no remaining undistributed goods associated with the most congested raffle, then process 800 continues at operation 812.

At operation 812, the market system determines whether there are one or more raffles having undistributed goods. If there are, then process 800 continues at operation 802, and the market system determines a congestion ratio for the remaining one or more raffles having undistributed goods. If there are no remaining raffles having undistributed goods, then process 800 continues at operation 814, where the market system concludes the distribution.

The processes 300, 500, 700, and 800 are described with reference to the architecture 100 and system 200 of FIGS. 1 and 2 for convenience and ease of understanding. However, the processes 300, 500, 700, and 800 are not limited to being performed using the architecture 100 and system 200. Moreover, the architecture 100 and system 200 are not limited to performing the processes 300, 500, 700, and 800.

The processes 300, 500, 700, and 800 are illustrated as collections of blocks in logical flow graphs, which represent sequences of operations that can be implemented in hardware, software, or a combination thereof In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some embodiments, one or more blocks of the process can be omitted entirely. Moreover, the processes 300, 500, 700, and 800 can be combined in whole or in part.

The various techniques described herein can be implemented in the context of computer-executable instructions or software, that are stored in computer-readable storage and executed by the processor(s) of one or more computers or other devices such as those illustrated in the figures. Generally, program modules include routines, programs, objects, components, data structures, etc., and define operating logic for performing particular tasks or implement particular abstract data types.

Other architectures can be used to implement the described functionality, and are intended to be within the scope of this disclosure. Furthermore, although specific distributions of responsibilities are defined above for purposes of discussion, the various functions and responsibilities might be distributed and divided in different ways, depending on circumstances.

Similarly, software can be stored and distributed in various ways and using different means, and the particular software storage and execution configurations described above can be varied in many different ways. Thus, software implementing the techniques described above can be distributed on various types of computer-readable media, not limited to the forms of memory that are specifically described.

### EXAMPLE A

A computing system for allocating indivisible goods amongst a set of market participants, the computing system comprising: at least one processing unit; and memory storing instructions executable by the at least one processing unit that, upon execution by the at least one processing unit, cause the computing system to: assign an amount of market resource to a market participant of a set of market participants; generate a user interface configured to: display a set of two or more raffles, individual raffles of the two or more raffles corresponding to a good, display a first congestion of a raffle of the two or more raffles, receive, via a first user input from the market participant, a first allocation of the amount of market resource between the two or more raffles; display, in response to receiving the first allocation, a second congestion of the raffle of the two or more raffles, and receive, via a second user input from the market participant, a second allocation of the amount of market resource between the two or more raffles; determine that the total amount of the market resource allocated to the raffle of the two or more raffles has converged to a state of equilibrium; and allocate one or more indivisible goods amongst the set of market participants based at least in part on the total amount of the market resource allocated to the raffle.

### EXAMPLE B

The system of Example A, wherein allocating the one or more indivisible goods comprises: identifying a first raffle of the two or more raffles as having a highest of congestion; randomly selecting a first market resource that has been allocated to the first raffle; determining that the first market resource is assigned to the market participant; and distributing a good to the market participant.

### EXAMPLE C

The system of any of the previous examples, alone or in combination: wherein the market participant is a first market participant and allocating the one or more indivisible goods comprises: removing market resource allocated to the first raffle that is assigned to the first market participant; randomly selecting a second market resource that has been allocated to the first raffle; determining that the second market resource is assigned to a second market participant; and distributing a second good to the second market.

### EXAMPLE D

The system of any of any of the previous examples, alone or in combination, wherein the instructions, upon execution by the at least one processing unit, further cause the computing system to determine a change of the total amount of the market resource allocated to the raffle from the first allocation to the second allocation.

### EXAMPLE E

The system of any of the previous examples, alone or in combination, wherein the instructions, upon execution by the at least one processing unit, further cause the computing system to determine a rate of presenting the change that will induce the two or more raffles to converge to the state of equilibrium.

### EXAMPLE F

The system of any of the previous examples, alone or in combination, wherein the instructions, upon execution by the at least one processing unit, further cause the computing system to: determine that the change meets or exceeds a threshold; and transmit, via a wireless communications network, an alert to one or more of the electronic device and a wireless electronic device associated with the market participant.

### EXAMPLE G

The system of any of the previous examples, alone or in combination, wherein the alert is configured to cause one or more of the electronic device and an additional electronic device to present a the graphical user interface, the graphical user interface being configured to display the change of the total amount of the market resource allocated to the raffle.

### EXAMPLE H

The system of any of the previous examples, alone or in combination, wherein the user interface further displays an indicator of a level of fluctuation of the total amount of the market resource allocated to the raffle.

### EXAMPLE I

A computer implemented method for allocating indivisible goods amongst a set of market participants, the method comprising: assigning an amount of market resource to a market participant of the set of market participants; generating a user interface that: displays a set of two or more raffles, individual raffles of the two or more raffles corresponding to a good, displays a first congestion of a raffle of the two or more raffles, receives, via first user input from the market participant, a first allocation of the amount of market resource amongst the two or more raffles; displays, in response to receiving the first allocation, a second congestion of the raffle, and receives, via second user input from the market participant, a second allocation of the market resource amongst the two or more raffles; determining that a total amount of the market resource allocated to the raffle has converged to a state of equilibrium; and allocating the indivisible goods amongst the set of market participants based at least in part on the total amount of the market resource allocated to the raffle.

### EXAMPLE J

The computer implemented method of Example I, wherein allocating the indivisible goods comprises: identifying a first raffle of the two or more raffles as having a highest congestion; randomly selecting a first market resource that has been allocated to the first raffle; determining that the first market resource is assigned to the market participant; and distributing a first good corresponding to the first raffle to the market participant.

### EXAMPLE K

The computer implemented method of any of Examples I and J, alone or in combination, wherein the market participant is a first market participant and allocating the indivisible goods further comprises: removing market resource from the first raffle that is assigned to the first market participant; randomly selecting a second market resource that has been allocated to the first raffle; determining that the second market resource is assigned to a second market participant; and distributing a second good corresponding to the first raffle to the second market participant. Example L: The computer implemented method of any of Examples I-K, alone or in combination, further comprising determining a change of the total amount of the market resource allocated to the raffle from the first allocation to the second allocation.

### EXAMPLE M

The computer implemented method of any of Examples I-L, alone or in combination, further comprising determining a rate of presenting the change that will induce the two or more raffles to converge to the state of equilibrium.

### EXAMPLE N

The computer implemented method of any of Examples I-M, alone or in combination, further comprising: determining that the change meets or exceeds a threshold; and transmitting, via a wireless communications network, an alert of the change to a wireless electronic device associated with the market participant.

### EXAMPLE O

The computer implemented method of any of Examples I-N, alone or in combination, wherein the user interface further displays an indicator of a level of fluctuation of the total amount of the market resource allocated to the raffle.

### EXAMPLE P

An electronic device for allocating indivisible goods amongst a set of market participants, the electronic device comprising: at least one processing unit; and memory storing instructions executable by the at least one processing unit that, upon execution by the at least one processing unit, cause the electronic device to: receive, from an additional electronic device associated with a computerized raffle system, an amount of market resource assigned to a market participant associated with the electronic device; generate, based at least in part on a first set of information received from the additional electronic device, a user interface configured to: display a set of two or more raffles, individual raffles of the two or more raffles corresponding to a good, and display a first congestion of a raffle of the two or more raffles, and receive, via a first user input from the market participant, a first allocation of the amount of market resource between the two or more raffles; transmit the first allocation to the additional electronic device; cause, based at least in part on a second set of information received from the additional electronic device, the user interface to display a second congestion of the raffle of the two or more raffles, and receive, via a second user input from the market participant, a second allocation of the amount of market resource between the two or more raffles; transmit the second allocation to the additional electronic device; receive, from the additional electronic device, an allocation of an indivisible good based at least in part on a total amount of the market resource allocated to the raffle.

### EXAMPLE Q

The electronic device of Example P, wherein the user interface is further configured to display an indicator of a level of fluctuation of the total amount of the market resource allocated to the raffle.

### EXAMPLE R

The electronic device of any of Examples P and Q, alone or in combination, wherein the user interface is further configured to display a change of the total amount of the market resource allocated to the raffle at a determined rate.

### EXAMPLE S

The electronic device of any of Examples P-R, alone or in combination, wherein the instructions, upon execution by the at least one processing unit, further cause the electronic device to receive, from the additional electronic device and via a wireless communications network, an alert indicative of a market state of the computerized raffle system.

### EXAMPLE T

The electronic device of any of Examples P-S, alone or in combination, wherein the instructions, upon execution by the at least one processing unit, further cause the electronic device to generate, based at least in part on the alert, the user interface, the user interface being configured to: display the market state of the computerized raffle system, and receive a third allocation of the amount of market resource between the two or more raffles.

### EXAMPLE U

A system for allocating indivisible goods amongst a set of market participants, the system comprising: means for executing computer-executable instructions (e.g., processors, including, for example, hardware processors such as central processing units (CPUs), system on chip (SoC), etc.); and a means for storing computer-executable instructions (e.g., memory, computer readable storage media such as RAM, ROM, EEPROM, flash memory, etc.), the means for storing including: means for assigning an amount of market resource to a market participant of a set of market participants; means for generating a user interface, the user interface including: means for displaying a set of two or more raffles, individual raffles of the two or more raffles corresponding to a good, means for displaying a first congestion of a raffle of the two or more raffles, means for receiving, via a first user input from the market participant, a first allocation of the amount of market resource between the two or more raffles; means for displaying, in response to receiving the first allocation, a second congestion of the raffle of the two or more raffles, and means for receiving, via a second user input from the market participant, a second allocation of the amount of market resource between the two or more raffles; means for determining that the total amount of the market resource allocated to the raffle of the two or more raffles has converged to a state of equilibrium; and means for allocating one or more indivisible goods amongst the set of market participants based at least in part on the total amount of the market resource allocated to the raffle.

### EXAMPLE V

The system of Example U, wherein the means for allocating the one or more indivisible goods comprises: means for identifying a first raffle of the two or more raffles as having a highest of congestion; means for randomly selecting a first market resource that has been allocated to the first raffle; means for determining that the first market resource is assigned to the market participant; and means for distributing a good to the market participant.

### EXAMPLE W

The system of any of Examples U and V, alone or in combination: wherein the market participant is a first market participant and allocating the one or more indivisible goods further comprises: means for removing market resource allocated to the first raffle that is assigned to the first market participant; means for randomly selecting a second market resource that has been allocated to the first raffle; means for determining that the second market resource is assigned to a second market participant; and means for distributing a second good to the second market.

### EXAMPLE X

The system of any of Examples U-W, alone or in combination, wherein the means for storing further includes: means for determining a change of the total amount of the market resource allocated to the raffle from the first allocation to the second allocation.

### EXAMPLE Y

The system of any of Examples U-X, alone or in combination, wherein the means for storing further includes: means for determining a rate of presenting the change that will induce the two or more raffles to converge to the state of equilibrium.

### EXAMPLE Z

The system of any of Examples U-Y, alone or in combination, wherein the means for storing further includes: means for determining that the change meets or exceeds a threshold; and means for transmiting, via a wireless communications network, an alert to one or more of the electronic device and a wireless electronic device associated with the market participant.

### EXAMPLE AA

The system of any of Examples U-Z, alone or in combination, wherein the alert comprises means to cause one or more of the electronic device and an additional electronic device to present a the graphical user interface, the graphical user interface being configured to display the change of the total amount of the market resource allocated to the raffle.

### EXAMPLE BB

The system of any of Examples U-AA, alone or in combination, wherein the user interface further includes means for displaying an indicator of a level of fluctuation of the total amount of the market resource allocated to the raffle.

### CONCLUSION

In closing, although the various embodiments have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method for allocating indivisible goods amongst a set of market participants, the method comprising:
assigning an amount of market resource to a market participant of the set of market participants;
generating a user interface that:
displays a set of two or more raffles, individual raffles of the two or more raffles corresponding to a good, displays a first congestion of a raffle of the two or more raffles,
receives, via first user input from the market participant, a first allocation of the amount of market resource amongst the two or more raffles;
displays, in response to receiving the first allocation, a second congestion of the raffle, and
receives, via second user input from the market participant, a second allocation of the market resource amongst the two or more raffles;
determining that a total amount of the market resource allocated to the raffle has converged to a state of equilibrium; and
allocating the indivisible goods amongst the set of market participants based at least in part on the total amount of the market resource allocated to the raffle.

2. The method of claim 1, wherein allocating the indivisible goods comprises:
identifying a first raffle of the two or more raffles as having a highest congestion;
randomly selecting a first market resource that has been allocated to the first raffle;
determining that the first market resource is assigned to the market participant; and
distributing a first good corresponding to the first raffle to the market participant.

3. The method of claim 2, wherein the market participant is a first market participant and allocating the indivisible goods further comprises:
removing market resource from the first raffle that is assigned to the first market participant;
randomly selecting a second market resource that has been allocated to the first raffle;
determining that the second market resource is assigned to a second market participant; and
distributing a second good corresponding to the first raffle to the second market participant.

4. The method of claim 1, further comprising determining a change of the total amount of the market resource allocated to the raffle from the first allocation to the second allocation.

5. The method of claim 4, further comprising determining a rate of presenting the change that will induce the two or more raffles to converge to the state of equilibrium.

6. The method of claim 4, wherein the user interface displays an indicator of a level of fluctuation of the total amount of the market resource allocated to the raffle.

7. The method of claim 4, further comprising:
determining that the change meets or exceeds a threshold; and
transmitting, via a wireless communications network, an alert of the change to a wireless electronic device associated with the market participant.

8. A computing system comprising:
at least one processing unit; and
memory storing instructions executable by the at least one processing unit that, upon execution by the at least one processing unit, cause the computing system to:
assign an amount of market resource to a market participant of a set of market participants;
generate a user interface configured to:
display a set of two or more raffles, individual raffles of the two or more raffles corresponding to a good,
display a first congestion of a raffle of the two or more raffles,
receive, via a first user input from the market participant, a first allocation of the amount of market resource between the two or more raffles;
display, in response to receiving the first allocation, a second congestion of the raffle of the two or more raffles, and
receive, via a second user input from the market participant, a second allocation of the amount of market resource between the two or more raffles;
determine that the total amount of the market resource allocated to the raffle of the two or more raffles has converged to a state of equilibrium; and
allocate one or more indivisible goods amongst the set of market participants based at least in part on the total amount of the market resource allocated to the raffle.

9. The computing system of claim 8, wherein allocating the one or more indivisible goods comprises:
identifying a first raffle of the two or more raffles as having a highest of congestion;
randomly selecting a first market resource that has been allocated to the first raffle;
determining that the first market resource is assigned to the market participant; and
distributing a good to the market participant.

10. The computing system of claim 9, wherein the market participant is a first market participant and allocating the one or more indivisible goods comprises:
removing market resource allocated to the first raffle that is assigned to the first market participant;
randomly selecting a second market resource that has been allocated to the first raffle;
determining that the second market resource is assigned to a second market participant; and
distributing a second good to the second market.

11. The computing system of claim 8, wherein the instructions, upon execution by the at least one processing unit, further cause the computing system to determine a change of the total amount of the market resource allocated to the raffle from the first allocation to the second allocation.

12. The computing system of claim 11, wherein the instructions, upon execution by the at least one processing unit, further cause the computing system to determine a rate of presenting the change that will induce the two or more raffles to converge to the state of equilibrium.

13. The computing system of claim 11, wherein the user interface further displays an indicator of a level of fluctuation of the total amount of the market resource allocated to the raffle.

14. The computing system of claim 11, wherein the instructions, upon execution by the at least one processing unit, further cause the computing system to:
determine that the change meets or exceeds a threshold; and
transmit, via a wireless communications network, an alert to one or more of the electronic device and a wireless electronic device associated with the market participant.

15. The computing system of claim 14, wherein the alert is configured to cause one or more of the electronic device and an additional electronic device to present a the graphical user interface, the graphical user interface being configured to display the change of the total amount of the market resource allocated to the raffle.

16. An electronic device, comprising:
at least one processing unit; and
memory storing instructions executable by the at least one processing unit that, upon execution by the at least one processing unit, cause the electronic device to:
receive, from an additional electronic device associated with a computerized raffle system, an amount of market resource assigned to a market participant associated with the electronic device;
generate, based at least in part on a first set of information received from the additional electronic device, a user interface configured to:
display a set of two or more raffles, individual raffles of the two or more raffles corresponding to a good, and
display a first congestion of a raffle of the two or more raffles, and
receive, via a first user input from the market participant, a first allocation of the amount of market resource between the two or more raffles;
transmit the first allocation to the additional electronic device;
cause, based at least in part on a second set of information received from the additional electronic device, the user interface to display a second congestion of the raffle of the two or more raffles, and
receive, via a second user input from the market participant, a second allocation of the amount of market resource between the two or more raffles;
transmit the second allocation to the additional electronic device;
receive, from the additional electronic device, an allocation of an indivisible good based at least in part on a total amount of the market resource allocated to the raffle.

17. The electronic device of claim 16, wherein the user interface is further configured to display an indicator of a level of fluctuation of the total amount of the market resource allocated to the raffle.

18. The electronic device of claim 16, wherein the user interface is further configured to display a change of the total amount of the market resource allocated to the raffle at a determined rate.

19. The electronic device of claim 16, wherein the instructions, upon execution by the at least one processing unit, further cause the electronic device to receive, from the additional electronic device and via a wireless communications network, an alert indicative of a market state of the computerized raffle system.

20. The electronic device of claim 19, wherein the instructions, upon execution by the at least one processing unit, further cause the electronic device to generate, based at least in part on the alert, the user interface, the user interface being configured to:
display the market state of the computerized raffle system, and
receive a third allocation of the amount of market resource between the two or more raffles.
